(19) United States
(12) Patent Application Publication
(10) Pub. No.: US 2015/0039141 A1
(43) Pub. Date: Feb. 5, 2015

(54) SYSTEM AND METHOD USING FUZZY LOGIC FOR RESOURCE CONSERVATION

(71) Applicant: Wayne State University, Detroit, MI (US)

(72) Inventors: Macam S. Dattathreya, Sterling Heights, MI (US); Harpreet Singh, Detroit, MI (US)

(21) Appl. No.: 14/446,493

(22) Filed: Jul. 30, 2014

Related U.S. Application Data
(60) Provisional application No. 61/859,934, filed on Jul. 30, 2013.

(51) Int. Cl. G06Q 50/06; G06N 7/02; G05D 7/06; H02J 7/00; H05B 37/02

(52) U.S. Cl. CPC G06Q 50/06; H02J 7/007; H05B 37/0218; G05D 7/0617; G06N 7/02
USPC 700/282; 320/128; 307/26; 315/149

(57) ABSTRACT

Control systems and devices for fuzzy logic control are disclosed. The devices may include various inputs, outputs, and levels thereof that may be controlled, for example by a logic controller.

### CROSS REFERENCE TO RELATED APPLICATIONS

This application claims the benefit of U.S. Provisional Patent Application No. 61/859,934 filed Jul. 30, 2013, the content of which is hereby incorporated by reference in its entirety.

### TECHNICAL FIELD

The present invention relates to logic control, and more particularly to fuzzy logic control of systems to promote efficiency.

### BACKGROUND

Conventional control systems may be limited having only an “on” state and an “off” state. Such systems may cause significant waste due to limited control of system outputs. Systems for advanced control of various system outputs and environmental variables may be applied to limit waste while improving the interaction of users. Examples of such systems and methods may be disclosed herein.

### BRIEF DESCRIPTION OF THE DRAWINGS

Certain features of the subject technology are set forth in the appended claims. However, for purpose the of explanation, one or more implementations of the subject technology are set forth in the following figures.

FIG. 1a is a diagram of an environment and a system for energy management;

FIG. 1b is an example of a flow chart of a method for energy management;

FIG. 1c is a visual representation of membership functions for an input of a fuzzy logic system;

FIG. 2 is an example of a block diagram of a logic controller demonstrating system inputs and outputs for energy management;

FIG. 3 is a diagram of an environment and a system for flow control;

FIG. 4 is an example of a block diagram of a controller demonstrating system inputs and outputs for flow control;

FIG. 5 is a diagram of an environment and a system for control of a lighting system;

FIG. 6 is an example of a block diagram of a controller demonstrating system inputs and outputs for control of a lighting system; and

FIG. 7 is an example of hardware which may be applied in some implementations of the disclosure.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, it will be clear and apparent to those skilled in the art that the subject technology is not limited to the specific details set forth herein and may be practiced using one or more implementations. In one or more instances, well-known structures and components are shown in block diagram form in order to avoid obscuring the concepts of the subject technology.

Systems and methods for managing and controlling systems through fuzzy logic may provide beneficial results in many forms. Energy and resource savings through advanced control may limit usage of valuable resources.

In some examples, the disclosed systems and methods may receive a plurality of system inputs at a plurality of levels in response to user and environmental variables. Some of the disclosed systems may be operable to control various devices through intuitive controls. Systems to improve control and user interaction of various devices may be implemented through control systems, some of which are detailed herein.

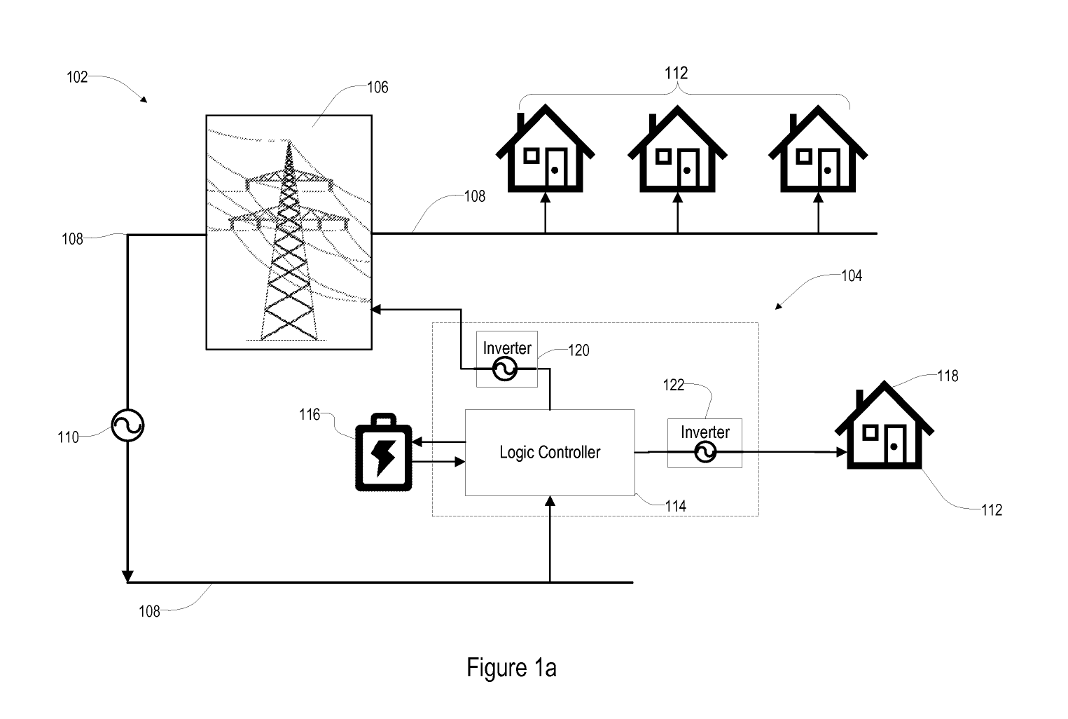

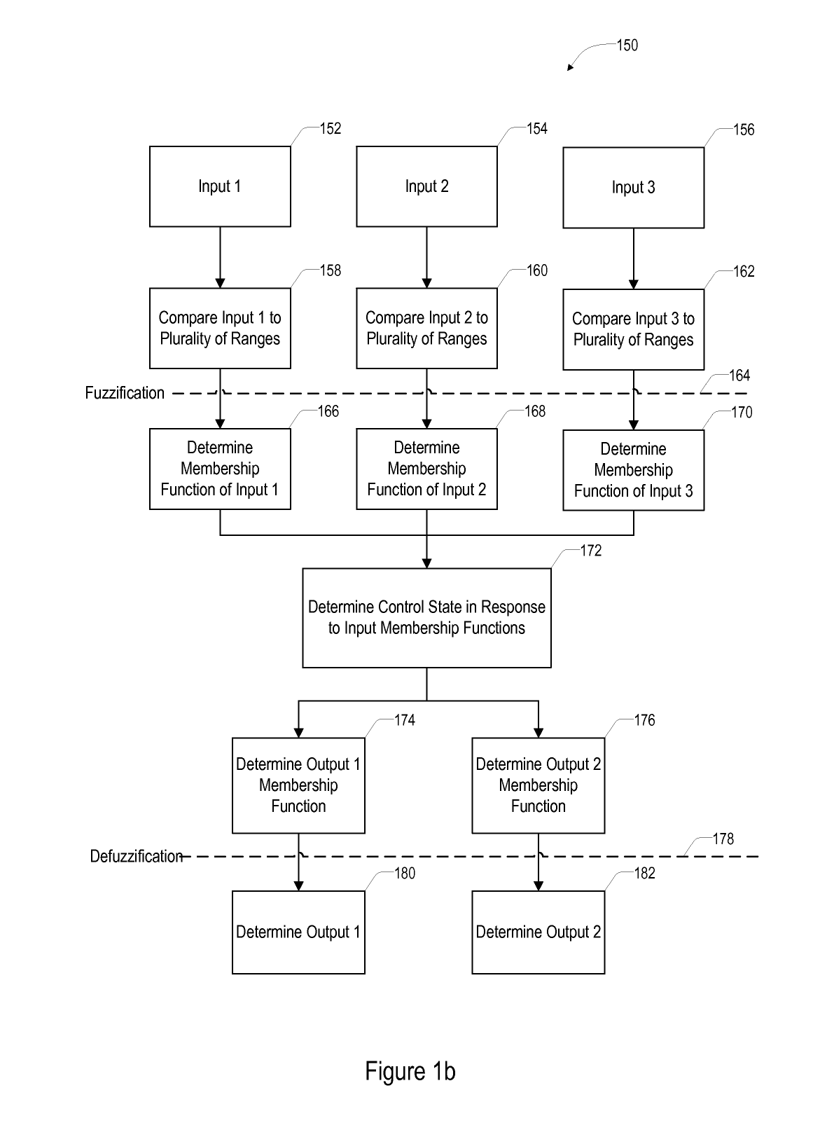

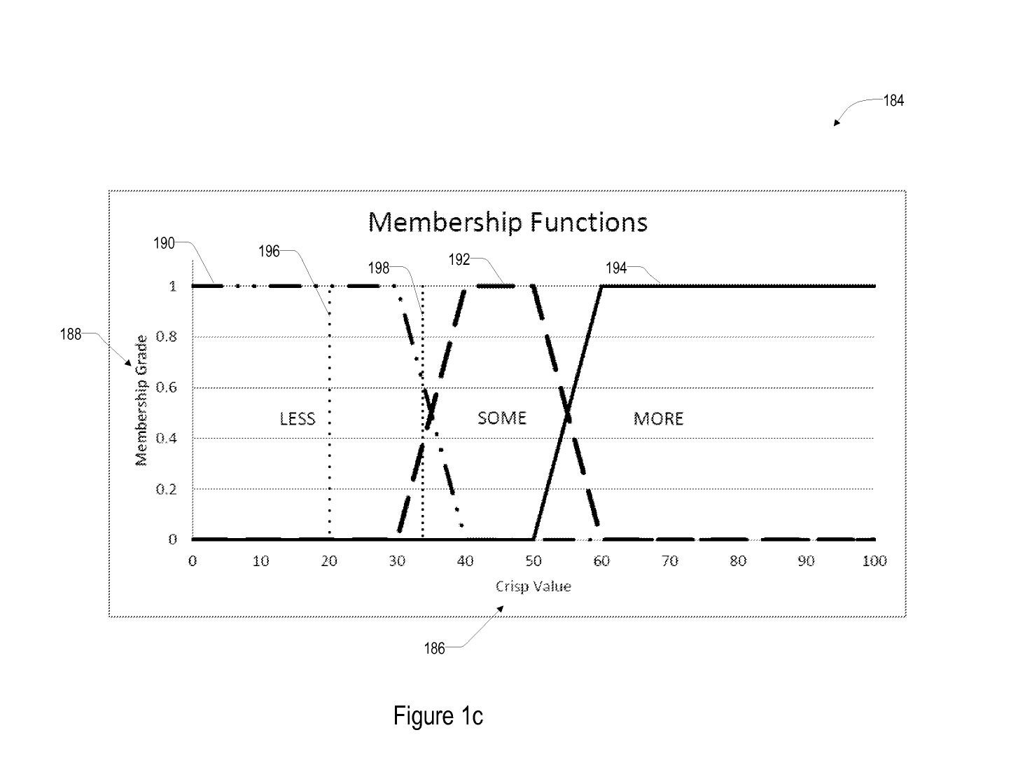

Referring to FIG. 1a, a diagram of an environment 102 and system for energy management 104 is shown in accordance with the disclosure. In one implementation, the system for energy management may be incorporated into an environment comprising an energy supply, for example a power grid 106. The power grid 106 may comprise various transformers, power generation systems, and electrical transmission lines. The power grid 106 may further comprise various systems and components that may be implemented to provide power to a variety of residences, business, and end users.

Transmission lines 108 may provide power to a plurality of residences 112. In this particular implementation, a supplied power 110 may be delivered in the form of alternating current (AC) as is common in many power systems. Interruptions in the supplied power 110 to a plurality of residences 112 may occur in the event of spikes in energy demand or shortages in power supplied by the power grid 106. Such interruptions may be more common in developing regions that may lack sufficient energy production and infrastructure to meet the demands of consumers. In this implementation, the system for energy management 104 may serve to limit temporary outages or brownouts due to insufficient power supplied to the plurality of residences.

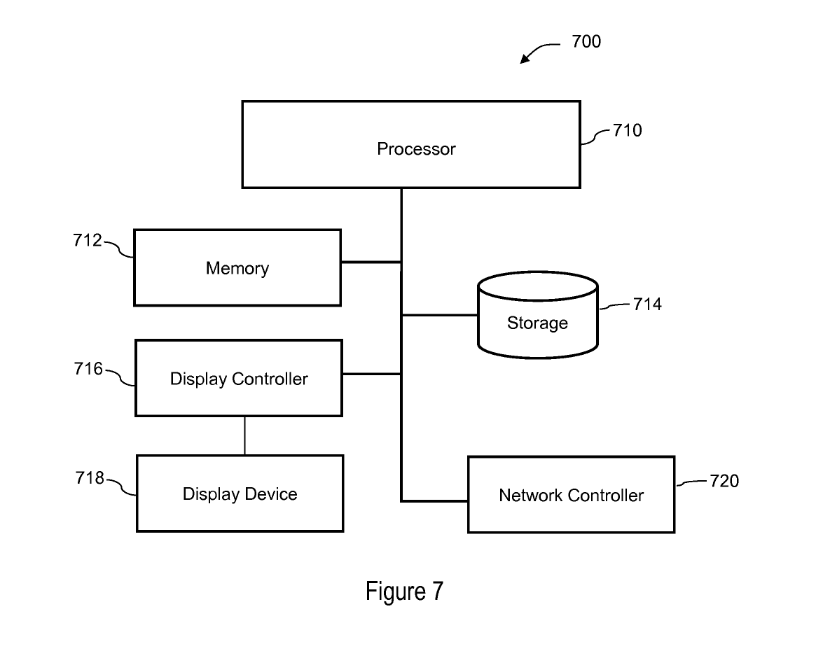

The system for energy management 104 may comprise a logic controller 114, for example a fuzzy logic controller, and an energy storage unit 116. The logic controller 114 may comprise various components, processors, integrated circuits, communication modules, and user interface modules. One implementation of a controller that may be implemented in the system for energy management 104 is described in reference to FIG. 7. The energy storage unit 116 may comprise various forms of rechargeable batteries, for example lead acid, lithium ion, Nickel-Cadmium, Nickel-Metal-Hydride, and other rechargeable batteries. The implementations of the system for energy management 104 may not be limited to the particular examples referred to herein.

The logic controller may control the supply of power to at least one controlled residence 118. The logic controller may control the power supplied to the at least one controlled residence 118 by monitoring a plurality of system inputs. In this implementation, the system inputs may comprise an available current from the power grid 106 supplied by the transmission lines 108, a stored energy level of energy of the energy storage unit 116, and a discharge rate of stored energy of the energy storage unit 116 to local appliances of the controlled residence 118. The system inputs may be measured by the logic controller 114 at a plurality of levels to control a plurality of system outputs.

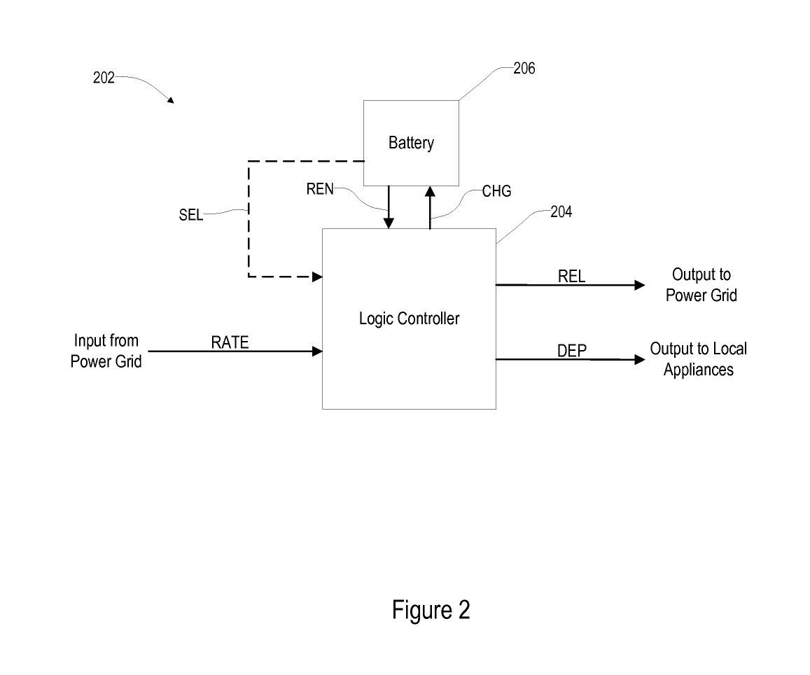

In some implementations, the system outputs may comprise a charging rate of the energy storage unit 116 and a rate of energy return to the power grid 106. Similar to the system inputs, the system outputs may be controlled at a plurality of output levels. Each of the plurality of output levels of the plurality of system outputs may vary in response to each of the input levels of the plurality of system inputs. The input levels and output levels may vary in each system and may also vary based on the particular environment in which a system for energy management is implemented. Further details referring to an example system for energy management including particular system inputs, system outputs, and levels thereof is discussed in reference to FIG. 2.

Each of the system inputs may be measured by one or more measurement devices. The measurement devices may comprise a plurality of circuits and/or components configured to measure the system inputs to the logic controller 114. The measurement devices may be incorporated into the system for energy management 104 and measure current, voltage, ampere hours, etc. For example, the available current from the power grid 106 may be measured by any device, component, and/or circuit operable to measure current, (e.g. one or more amp meters). The discharge rate of stored energy of the energy storage unit 116 may be measured similar to the available current from the power grid 106. The stored energy level from the energy storage unit 116 may be measured by any device, component, and/or circuit operable to measure the stored energy level of an energy storage unit, (e.g. a voltmeter or an amp hour meter).

The measurement devices may be operable to communicate via analog or digital signals with the logic controller 114. For example, the available current from the power grid 106 may be communicated as a digital input to the logic controller 114. In one implementation, the digital input may range for example from 0 to 99 or 0 to 999. The measurement devices may be integrated in the logic controller 114 or be configured to communicate with the logic controller 114 as one or more components of the system for energy management 104. The measurement devices may be operable to measure for example, current, voltage, or other properties of the plurality of system inputs.

The energy management system 104 may generally operate by converting the AC supplied by the power grid 106 to direct current (DC) to charge the energy storage unit 116. A first inverter 120 may convert DC power from the battery using the logic controller to AC power. The AC power from the first inverter 120 may supply power to back to the power grid 106. In some implementations, additional circuitry may be incorporated into the energy management system 104 to align the phase of the AC power generated by the first inverter 120 with the AC power of the power grid 106. Aligning the phase of the power generated by the first inverter 120 with the phase of the power of the power grid 106 may provide for safe and efficient supply of power to the power grid 106.

A second inverter 122 may supply AC power to the controlled residence 118 for usage by a plurality of local appliances. Local appliances may comprise any devices or systems that may consume electrical energy in operation. Conversion from AC to DC and DC to AC may be accomplished by rectification of the AC and inversion of the DC, respectively. Various systems and methods for conversion of power from AC to DC and DC to AC may be applied in accordance with the various implementations of the disclosure. Though the second inverter 122 is disclosed in this implementation, a first inverter may supply power to both the power grid 106 and the controlled residence 118 in some implementations.

The charging of the energy storage unit 116 may be controlled by the logic controller 114 by varying the output current to the battery. In this implementation, DC current may be supplied to the energy storage unit 116 for charging. The output current to the energy storage unit 116 from the logic controller 114 may vary in response to a plurality of system inputs of the logic controller 114. Though a single controlled residence 118 is discussed in reference to this implementation, a plurality of residences, business, etc. may be controlled to provide substantial power back to the power grid 106.

Referring to FIG. 1b, an example of a flow chart of a method 150 for energy management is shown in accordance with the disclosure. The method 150 may comprise receiving a plurality of system inputs for a logic controller, for example a first input corresponding to the available current from a power grid 152. A second input may correspond to the stored energy level of an energy storage unit 154. A third input may correspond to a discharge rate of stored energy from an energy storage unit 156.

Upon receipt of the plurality of system inputs, a crisp value of each of the system inputs may be compared to a range. The first input may be compared to a plurality of ranges 158. The second input may be compared to a plurality of ranges 160. The third input may also be compared to a plurality of ranges 162. Each of the plurality of ranges may be defined by a user or predefined for a particular logic controller. Each of the plurality of ranges may comprise a first threshold and a second threshold corresponding to a minimum value and maximum value of a particular range.

The comparison of each of the first input, the second input, and the third input to each of the respective ranges may yield a membership grade for each of the plurality of inputs. This assignment of a membership grade may be described as fuzzification of the plurality of inputs 164. For example, the logic controller may determine a membership grade for the first input 166. The logic controller may also determine a membership grade for the second input 168. The logic controller may also determine a membership grade for the third input 170.

Once the membership grades for each of the plurality of inputs have been determined, the logic controller may determine a control state in response to the input membership grades 172. The control states may be predefined or user defined. The control states may be configured to define a plurality of output membership grades in response to a particular control state. Based on the control state, the logic controller may determine a membership grade for a first output 174. The logic controller may also determine a membership grade for a second output 176. Each of the membership grades for the plurality of outputs may then be defuzzified 178, for example by assigning a signal output or numeric output corresponding to predetermined or user defined membership grades. A signal output may be assigned by activating at least one output from the logic controller. The at least one output may correspond to any output signal, for example a digital signal, or an analog current or voltage.

After defuzzification, a first output may be output from the logic controller 180. A second output may also be output from the logic controller 182. Each of the plurality of outputs may correspond to a control state of the logic controller, for example a range, signal, or value that may further control a state of an output device. A state of an output device may correspond to any state of operation of a particular output device. A state for an output device may comprise a plurality of output ranges corresponding to a plurality of thresholds. One particular example of a state of an output device may comprise a charging rate of an energy storage device having a plurality of ranges correspond a plurality of charging rates. This methodology can be applied to any of the implementations described herein.

Referring to FIG. 1c, a visual representation of membership functions 184 for an input of a fuzzy logic system is shown in accordance with the disclosure. The independent axis may represent a range of system inputs. Each system input received by a controller may correspond to a crisp value 186. The crisp value may correspond to a membership grade 188 based on a membership function. The three membership functions in this example are denoted as LESS 190, SOME 192, and MORE 194. Based on the membership grade 188, a membership function may be assigned to the system input through fuzzification.

In some instances, a membership grade may correspond directly to a membership function. For example, a first crisp value 196 may correspond to a membership grade of 1 for the membership function LESS 190. A crisp value, for example the first crisp value 196 may correspond to an input value from a system input. A crisp value may also correspond to a particular input value or output value within one of a plurality of input and output ranges. In another example, a second crisp value 198 may correspond to more than one membership function. In this example, a membership function applied by the controller may be determined from the membership functions of LESS 190 and SOME 192.

To determine an applicable membership function for the second crisp value 198, the controller may determine a membership grade for the membership functions of LESS 190 and MORE 194. A membership grade for LESS 190 is approximately 0.6 (60%), and the membership grade for SOME 192 is approximately 0.4 (40%). Based on the second crisp value, the membership functions of LESS 190 and SOME 192 may then be applied in a fuzzy inference with one or more inputs to determine an applicable output membership function for one or more system outputs. An example of fuzzy inferences corresponding to a plurality of control states is discussed later reference to Table 3.

Once one or more system inputs have been fuzzified, and a fuzzy inference has been determined, one or more outputs may be assigned through defuzzification. During defuzzification, one or more output membership functions may be applied to assign an output membership value. Defuzzification for a system output or a plurality of system outputs may be calculated by various methods. A controller may be configured to determine output values based on a plurality of output membership functions by calculating, for example a centroid of the plurality of output membership functions, a bisector, a mean of maximum, a smallest value of maximum, a largest value of maximum and other methods. The output membership functions applied for defuzzification may be similar to the input membership functions discussed in reference to FIG. 1c. Though the above methods are described, various methods may be applied to calculate the particular system output values from the output membership functions. The methodologies discussed in this implementation may be applied to any of the implementations described herein.

Referring to FIG. 2, an example of a block diagram of a control system 202 demonstrating system inputs and outputs for energy management is shown in accordance with the disclosure. A logic controller 204 may be implemented similar to the logic controller 114. Though the logic controller 204 may be implemented in a variety of environments, the environment 102 of FIG. 1 is referred in reference to FIG. 2 for clarity. The logic controller 204 may operate to charge an energy storage unit, for example a battery 206. The battery 206 may generally be charged when the available current supplied by the power grid 106 exceeds the demand for current by the controlled residence 118. The battery 206 may also be charged if the available current does not exceed the demand of the controlled resident 118. Once the battery 206 is charged, the charging rate may be decreased.

As previously discussed, the plurality of system inputs and the plurality of system outputs may each comprise a plurality of levels. For this implementation, the plurality of system inputs will be referred to as follows: current supply from the power grid (RATE), stored energy level (SEL) in the battery, and discharge rate of stored energy (REN) from the battery. The plurality of system outputs will be referred to as the charging rate of the energy storage unit (CHG) and the rate of energy return to the power grid (REL).

The plurality of system inputs and the plurality of system outputs may be received and output by the logic controller 204 as analog or digital signals. Each of the analog or digital signals may be converted by the logic controller 204 to a plurality of membership grades based on the desired range of each of the plurality of system inputs and the system outputs. For example, the RATE input may vary from 0 to 100. The logic controller 204 may convert the RATE values to a plurality of membership grades based on a plurality of input ranges. The input ranges in this implementation may be converted to plurality of membership grades by the logic controller 204.

In one example the plurality of ranges may comprise a first range from 0-40, a second range from 30 to 60, and a third range from 50 to 100. If the RATE is within one of the first range, the second range, or the third range the logic controller may convert the RATE to one of a plurality of membership functions based on the membership grades. The membership functions may be defined in linguistic terms. In this example, the linguistic terms may comprise membership functions of less, some, and more, corresponding to the first range, the second range and the third range. Though three input ranges are discussed in this example, the number of input and output ranges may vary widely based on the specific application of a logic controller, the level of control desired, the processing capacity of a logic controller, and other variables.

Table 1 demonstrates the relationship of the various ranges for each of the plurality of system inputs and the plurality of system outputs for this example. In operation these combinations and ranges may be specified or defined to suit a particular control environment.

TABLE 1
System Inputs and Output in Linguistic
Terms for Energy Management

| | |
|---|---|
| Membership | |
| Functions | Range |

System Inputs:

| | | |
|---|---|---|
| SEL, RATE, and REN | Less | 0-40% |
| | Some | 30-60% |
| | More | 50-100% |

System Outputs:

| | | |
|---|---|---|
| REL, CHG | Less | 0-40% |
| | Some | 30-60% |
| | More | 50-100% |

The logic controller 204 may set the plurality of outputs to a plurality of ranges in response to various combinations of the ranges of the system inputs. In this implementation, the ranges of the plurality of outputs in linguistic terms are less, more, and some. Each of the various combinations of system inputs and corresponding system outputs may be referred to as control states.

Each of the inputs and outputs introduced in Table 1 may comprise a signal, for example an analog or digital signal that may vary from a minimum input or output (0%) to a maximum input or output (100%). Each of the inputs and outputs may further comprise a plurality of ranges. The ranges may correspond to subdivisions of the inputs and outputs. In this example, each of the inputs and outputs is divided into three ranges (e.g. less, more, some). In other implementations, the inputs and outputs may be divided into any number of ranges, for example 5, 10, or 100.

The number of ranges may vary based on the particular application of a system. Each of the ranges of the plurality of ranges may be defined by a user or predefined in a particular system. Each the plurality of ranges may further comprise a first threshold and a second threshold corresponding to a minimum signal level and a maximum signal level for each range of a particular input or output signal. The first threshold and the second threshold for each range may be predefined or specified by a user.

One example of system inputs corresponding to a particular control state may comprise the stored level of energy (SEL) of the battery 206 being more, the available current from the grid (RATE) being more, and the discharge rate of stored energy (REN) being less. In response to these inputs, the logic controller 204 may set the outputs for the charging rate (CHG) of the battery 206 and the rate of energy return to the power grid (REL) to be more. An example of a list of control states corresponding to the present example is shown in Table 2.

TABLE 2
Example Control States for Logic
Controller for Energy Management

| System Inputs and Rules | System Outputs |
|---|---|
| SEL = more, RATE = More, REN = Less | REL = More, CHG = More |
| SEL = Some, RATE = More, REN = Less | REL = Some, CHG = More |
| SEL = Less, RATE = More, REN = Less | REL = Less, CHG = More |
| SEL = More, RATE = Some, REN = Less | REL = Some, CHG = More |
| SEL = More, RATE = Less, REN = Less | REL = Less, CHG = More |
| SEL = Some, RATE = Some, REN = Less | REL = Some, CHG = More |
| SEL = Some, RATE = Less, REN = Less | REL = Less, CHG = More |
| SEL = More, RATE = Less, REN = Some | REL = Less, CHG = More |
| SEL = More, RATE = Some, REN = Some | REL = Some, CHG = More |
| SEL = More, RATE = Some, REN = More | REL = Less, CHG = More |

Table 2 may demonstrate the control states of the logic controller 204 for the present implementation. Each of the system inputs and outputs may comprise a plurality of ranges based on the membership functions that may be adjusted to control a system for energy management.

One additional control state may further be implemented in the present example to control the system for energy management 102. In some cases, SEL may lack the stored energy to provide power to the controlled residence 118. In this case, the controlled residence 118 may operate entirely on power supplied by the power grid 106. However, if the power grid 106 is also providing an amount of power below a first predetermined threshold RATE to supply the controlled residence 118, the logic controller 204 may respond by changing operation to a brownout protection state. In the brown out protection state, the logic controller may set the system to an idle state until the amount of power from the power grid 106 is above a second predetermined threshold RATE to begin normal operation as previously described. Though the first threshold RATE and the second threshold RATE are described, the first threshold RATE and the second threshold RATE may define the same RATE or different RATEs.

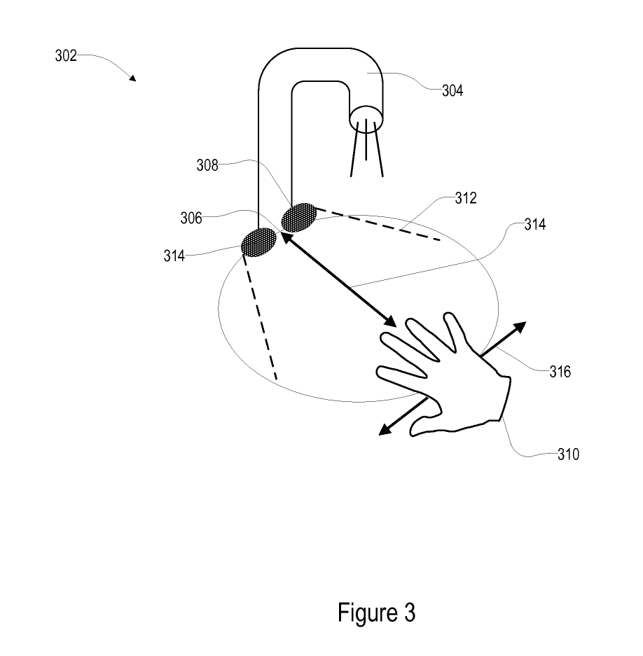

Referring to FIG. 3, a diagram of an environment and a system for flow control 302 is shown in accordance with the disclosure. In this implementation the system for flow control 302 may comprise a water faucet 304 having a flow control device 306, for example a transducer. The flow control device 306 may be applied to control the flow rate of water from the faucet. Though a water faucet is discussed in this implementation, the system for flow control 302 may be similarly implemented to control a variety of systems. Some exemplary systems may comprise a flow rate for the flushing of a toilet; faucets, fluid outlets, or ports for any fluid; and other systems that may be controlled by motion similar to the following.

The system for flow control 302 may comprise a first sensor 308. The first sensor 308 may be operable to sense presence, motion, and acceleration of an object, for example a hand 310, within a sensory range 312. Such a sensor may comprise an infrared sensor, ultra-sonic sensor, microwave sensor, or other sensors capable of detecting objects. The capability of the various sensors discussed herein to measure motion and acceleration may vary. As such, the measurements of two or more sensors may be implemented to monitor the object motion discussed in this disclosure.

In operation, the first sensor 308 may monitor the sensory range 312 for the presence or movement of an object, for example the hand 310. In response to the detection of the presence of the hand 310, the first sensor 308 may send a signal to a controller. In response to the signal, the controller may adjust an output controlling the flow control device 306, for example a transducer. The flow control device 306 may then adjust the flow rate to allow water to flow from the faucet.

In another example, the first sensor 308 may be configured to detect motion of an object, for example the hand 310. Upon the detection of motion, the first sensor 308 may output a signal to the controller. The signal output by the first sensor 308 may vary in response to a rate of motion that is sensed. For example, the first sensor 308 may have an output range from 0 to 3. In response to the detection of a slow rate of motion, the first sensor 308 may output a 1. In response to the detection of a medium or high rate of motion, the first sensor 308 may output a 2 or a 3, respectively. A rate of motion as disclosed may comprise any speed. In this example, the rate of motion (slow, medium, high) may be predefined.

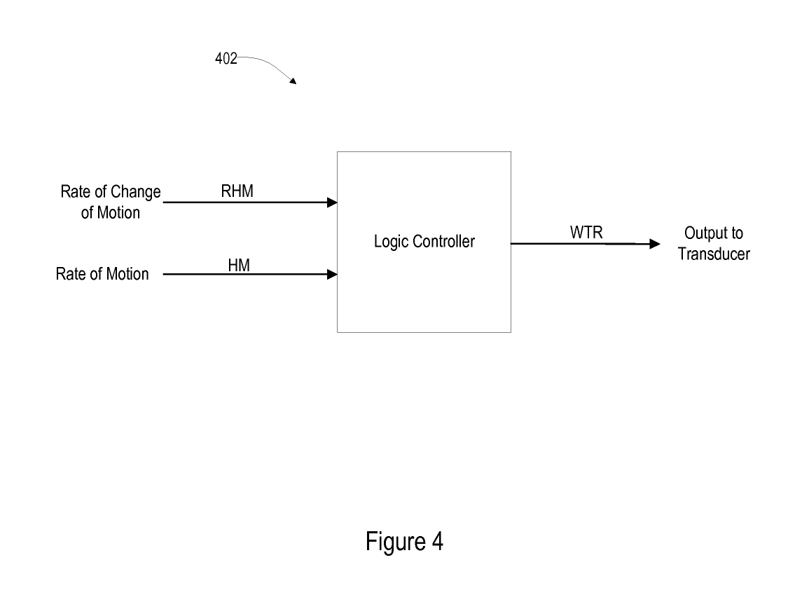

In response to the output from the first sensor 308 the controller may output a control signal to the flow control device to adjust the flow rate to a plurality of levels. Each of the plurality of levels may further correspond to a range of outputs. In this example the flow rate setting may comprise less, some, and more, corresponding to 1, 2, and 3. In some examples, the setting of the sensor output range and the controller output range may vary widely. Other variations of input and output ranges for one or more sensors are discussed further in reference to FIG. 4.

In another example, the first sensor 308 may be configured to measure the rate of change of motion (acceleration) of an object and the rate of motion of the object. In yet another example, a second sensor 314 may further be incorporated in the construction of the water faucet 304. The combined detection of the first sensor 308 and the second sensor 314 may provide for detection of the presence, motion, and acceleration of objects within the sensory range 312. The first sensor 308 and the second sensor 314 may further comprise two different sensors types with the combined capability to function as disclosed herein.

Referring to FIG. 4, an example of a block diagram of a controller 402 demonstrating system inputs and outputs for flow control is shown in accordance with the disclosure. In this example, the inputs into the controller 402 from a first sensor, a first sensor and second sensor, or a plurality of sensors may be referred to as the inputs from at least one sensor. The at least one sensor may measure a rate of motion (HM) and a rate of change of motion (RHM). The inputs into the controller 402 for the HM and the RHM may be converted into a plurality of membership functions. In response to the inputs, the controller 402 may be configured to output a plurality of membership functions corresponding to output signals to control the flow rate (WTR) of a flow control device.

The controller 402 may assign a plurality of membership functions in response to the inputs from the at least one sensor. Table 3 demonstrates the relationship of the various ranges for each of the plurality of system inputs and the plurality of system outputs for the controller 402. In operation, these combinations and ranges may be specified or defined to suit a particular control environment.

TABLE 3
System Inputs and Output in Linguistic Terms for Flow Control

| | |
|---|---|
| Membership | |
| Functions | Range |

Inputs

| | | |
|---|---|---|
| HM, RHM | less | 0-40% |
| | some | 30-60% |
| | more | 50-100% |

Outputs

| | | |
|---|---|---|
| WTR | less | 0-40% |
| | some | 30-60% |
| | more | 50-100% |

In response to various combinations of the ranges of the system inputs, the controller 402 may set the system outputs to control the flow rate (WTR) of a flow control device. Each of the various combinations of system inputs and corresponding system outputs may be referred to as control states. A control state may comprise a predetermined relationship of a plurality of system inputs and a corresponding plurality of system outputs.

Each of the inputs and outputs introduced in Table 3 may comprise a signal, for example an analog or digital signal, that may vary from a minimum input or output (0%) to a maximum input or output (100%). Each of the inputs and outputs may further comprise a plurality of ranges. The ranges may correspond to subdivisions of the inputs and outputs. In this example, each of the inputs and outputs may be divided into three ranges (e.g. less, more, some). In other implementations, the inputs and outputs may be divided into any number of ranges, for example 5, 10, or 100.

The number of ranges may vary based on the particular application. Each of the ranges of the plurality of ranges may be defined by a user or predefined in a particular system. Each the plurality of ranges may further comprise a first threshold and a second threshold corresponding to a minimum signal level and a maximum signal level for each range of a particular input or output signal. The first threshold and the second threshold for each range may be predefined or specified by a user.

One example of system inputs corresponding to a particular control state may comprise the rate of motion being more and the rate of change of motion being more. In response to these inputs, the controller 402 may set the output flow rate (WTR) of the flow control device to more. In this example, the at least one sensor may sense hand motion and a rate of change of hand motion that may be similar to someone waving. The actual rate of motion and rate of change of motion that corresponds to the input, more, may be defined and tuned for specific applications. An example of an entire list of control states corresponding to the present implementation is shown in Table 4.

TABLE 4
Example Control States for Logic
Controller for Energy Management

| Inputs and Rules | Outputs |
|---|---|
| HM = More, RHM = More | WTR = More |
| HM = More, RHM = Some | WTR = Some |
| HM = More, RHM = Less | WTR = Less |
| HM = Some, RHM = Less | WTR = Less |
| HM = Some, RHM = Some | WTR = Some |
| HM = Some, RHM = Less | WTR = Less |
| HM = Less, RHM = More | WTR = Less |
| HM = Less, RHM = Some | WTR = Less |
| HM = Less, RHM = Less | WTR = Less |

Table 4 illustrates the various control states for the controller 402 in this implementation. The controller 402 may output a plurality of signals in response to the various control states outlined in Table 4. The plurality of signals may be output to a flow control device, for example a transducer, a variable state solenoid valve, a ball valve, a diaphragm valve, or a proportional valve. In general the flow rate allowed through flow control device may increase in response to a higher rate of motion and a higher rate of change of motion.

The controller 402 may also be operable to change the output, WTR, in response to a timer. For example, the flow rate may change from more to less in response to an amount of time elapsing after an input, HM or RHM. This may ensure that the controller operates to conserve water, but also may provide for a delayed response to fluctuations in motion. This may further support intuitive operation by a user of a water faucet.

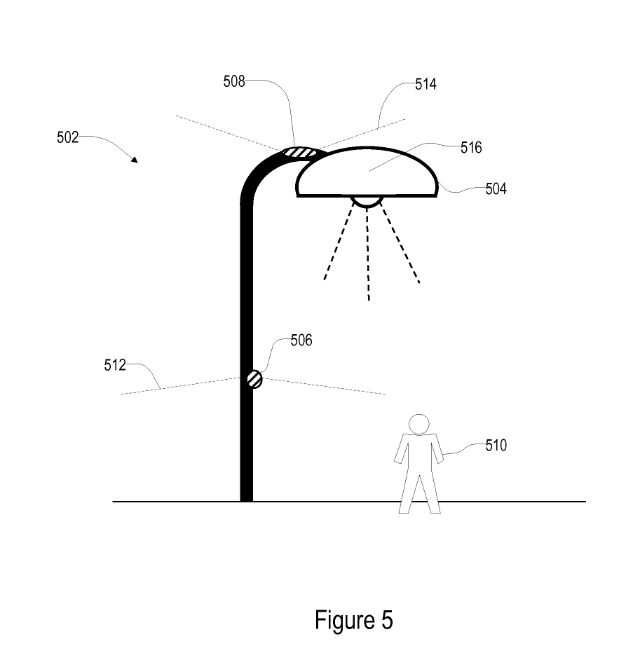

Referring to FIG. 5, a diagram of an environment and a system for control of a lighting system 502 is shown in accordance with the disclosure. In this implementation, the lighting system 502 may comprise at least one light source 504, a first sensor 506, and a second sensor 508. The at least one light source may comprise a single light source, or a plurality of light sources that may be controlled by the lighting system 502. The at least one light source may comprise for example lighting in rooms, hallways, parking lots, roads, etc. The at least one light source may comprise a light source being operable to output a varying amount of light. The amount of light output by the at least one light source may depend on an input from a controller.

The controller may be configured to receive one or more signals from the first sensor 506 and the second sensor 508. The first sensor may comprise a sensor that is operable to detect the motion of an object, for example a person 510. The first sensor may comprise, for example, a single sensor, a plurality of sensors or a sensor array configured to detect an amount of motion of at least one object moving through a sensory area 512. The first sensor 506 may comprise one or more infrared sensors, ultra-sonic sensors, microwave sensors, or other sensors capable of detecting motion of at least one object. Upon detection of the motion of an object, the first sensor 506 may output a first signal. The first signal may comprise an analog or digital output that may correspond to an amount of motion detect in the sensory area 512.

The second sensor 508 may comprise at least one sensor that is operable to detect an amount of light present within a proximity 514 of the lighting system 502. The proximity 514 may vary based on the particular lighting characteristics and properties of a lighting system. The proximity 514 may generally depend on characteristics of a particular sensor, but preferably may extend proximate to the boundaries of an effective lighting range of a light source. The second sensor 508 may comprise one or more sensors, or an array of sensors that are operable to detect light, for example photodetectors, active pixel sensors, a photoresistors, or photovoltaic cells. Upon detection of light, the second sensor 508 may output a second signal. The second signal may comprise an analog or digital output that may correspond to an amount of light detected in proximity to the lighting system.

In response to the first signal and the second signal, the controller may output a signal to a lighting control device. The lighting control device may comprise, for example, a variable position switch, rheostat, transformer, or any other device operable to dim a light source in response to an input. The lighting control device may be operable to output current corresponding to an amount of light in response to a plurality of outputs from the controller. The plurality of outputs may be determined by the controller in response to at least one input from one of the first sensor 506 and the second sensor 508.

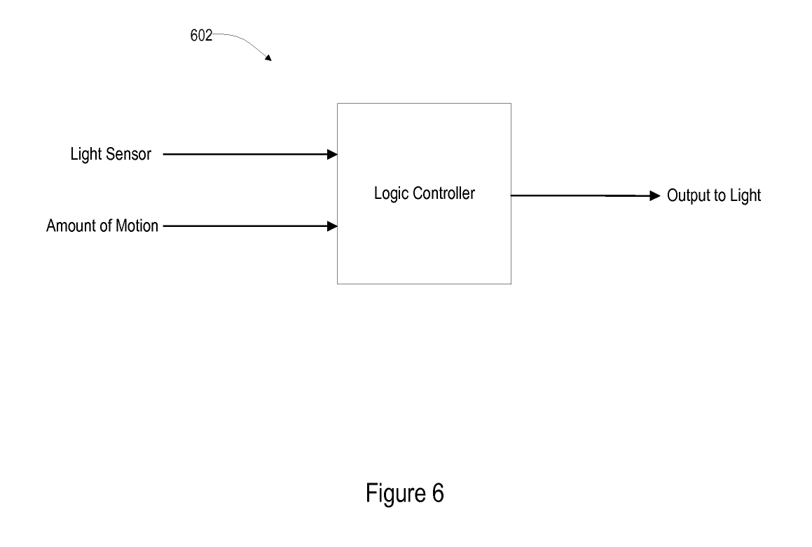

Referring to FIG. 6, an example of a block diagram of a controller 602 demonstrating system inputs and outputs for control of a lighting system is shown in accordance with the disclosure. In this example, the inputs into the controller 602 from a first sensor and a second sensor may be referred to as an amount of motion (MN) and an amount of light (LGT). The inputs into the controller 602 for the MN and the LGT may be converted into a plurality of membership functions. In response to the inputs, the controller 602 may be configured to output a plurality of membership functions corresponding to output signals to control the brightness (BRT) of a light source.

The controller 602 may assign a plurality of membership functions in response to the inputs from the first sensor and the second sensor. Table 5 demonstrates the relationship of the various ranges for each of the plurality of system inputs and outputs from the controller. In operation, these combinations and ranges may be specified or defined to suit a particular control environment.

TABLE 5
System Inputs and Output in Linguistic Terms for Lighting Control

| | |
|---|---|
| Membership | |
| Functions | Range |

Inputs

| | | |
|---|---|---|
| MN, LGT | less | 0-40% |
| | some | 30-60% |
| | more | 50-100% |

Outputs

| | | |
|---|---|---|
| BRT | less | 0-40% |
| | some | 30-60% |
| | more | 50-100% |

In response to various combinations of the ranges of the system inputs, the controller 602 may set the system outputs to control the brightness (BRT) of the light source. Each of the various combinations of system inputs and corresponding system outputs may be referred to as control states.

Each of the inputs and outputs introduced in Table 5 may comprise a signal, for example an analog or digital signal that may vary from a minimum input or output (0%) to a maximum input or output (100%). Each of the inputs and outputs may further comprise a plurality of ranges. The ranges may correspond to subdivisions of the inputs and outputs. In this example, each of the inputs and outputs is divided into three ranges (e.g. less, more, some). In other implementations, the inputs and outputs may be divided into any number of ranges, for example 5, 10, or 100.

The number of ranges may vary based on the particular application. Each of the ranges of the plurality of ranges may be defined by a user or predefined in a particular system. Each the plurality of ranges may further comprise a first threshold and a second threshold corresponding to a minimum signal level and a maximum signal level for each range of a particular input or output signal. The first threshold and the second threshold for each range may be predefined or specified by a user.

One example of system inputs corresponding to a particular control state may comprise the amount of motion being more and the amount of light being more. In response to these inputs, the controller 602 may set the output brightness (BRT) to the lighting controller of the light source to less. In operation, the input and output signals of this example may correspond to the first sensor detecting more motion and the second sensor detecting more light. In response to the inputs, the controller may output a signal to a lighting controller corresponding less light output from a light source. An example of a list of control states corresponding to the present example is shown in Table 6.

TABLE 6
Example Control States for Logic
Controller for Energy Management

| Inputs and Rules | Outputs |
|---|---|
| MN = More, LGT = More | BRT = Less |
| MN = More, LGT = Some | BRT = Less |
| MN = More, LGT = Less | BRT = More |
| MN = Some, LGT = More | BRT = Less |
| MN = Some, LGT = Some | BRT = Less |
| MN = Some, LGT = Less | BRT = Some |
| MN = Less, LGT = More | BRT = Less |
| MN = Less, LGT = Some | BRT = Less |
| MN = Less, LGT = Less | BRT = Less |

Table 6 illustrates the various control states for the controller 602 in this implementation. The control states may demonstrate one or more outputs from the controller 602 in response to at least one input. The lighting system may be operable to conserve energy by activating a light source at varying levels of brightness in response to an amount of light in proximity to the lighting system and the amount of motion present within a sensory range of the lighting system. The lighting system may conserve energy while providing effective lighting at variable levels in response to an amount of motion and an amount of lighting.

The controller 602 may also operable to change the output, BRT, in response to a timer. For example, the light output may change from more to less in response to an amount of time elapsing after an input, MN or LGT. This may ensure that the controller operates to conserve energy, but also may provide for a delayed response to fluctuations in motion and lighting.

Referring to FIG. 7 an example of hardware which may be applied in some implementations of the disclosure is shown. Any of the modules, controllers, logic controllers, and processors described may be implemented in one or more controllers. The controller 700 includes a processor 710 for executing instructions such as those described in the methods discussed above. The instructions may be stored in a computer-readable medium such as memory 712 or storage devices 714, for example a disk drive, CD, or DVD. The controller 700 may include a display controller 716 responsive to instructions to generate a textual or graphical display on a display device 718, for example a monitor. In addition, the processor 710 may communicate with a network controller 720 to communicate data or instructions to/from other systems, for example general computer systems. The network controller 720 may communicate over Ethernet or other known protocols to distribute processing or provide remote access to information over a variety of network topologies, including local area networks, wide area networks, the Internet, or other commonly used network topologies.

The methods, devices, logic controllers, and controllers described above may be implemented in many different ways in many different combinations of hardware, software or both hardware and software. For example, all or parts of the system may include circuitry in a controller, a microprocessor, or an application specific integrated circuit (ASIC), or may be implemented with discrete logic or components, or a combination of other types of analog or digital circuitry, combined on a single integrated circuit or distributed among multiple integrated circuits. All or part of the logic described above may be implemented as instructions for execution by a processor, controller, or other processing device and may be stored in a tangible or non-transitory machine-readable or computer-readable medium such as flash memory, random access memory (RAM) or read only memory (ROM), erasable programmable read only memory (EPROM) or other machine-readable medium such as a compact disc read only memory (CDROM), or magnetic or optical disk. Thus, a product, such as a computer program product, may include a storage medium and computer readable instructions stored on the medium, which when executed in an endpoint, computer system, or other device, cause the device to perform operations according to any of the description above.

The processing capability of the system may be distributed among multiple system components, such as among multiple processors and memories, optionally including multiple distributed processing systems. Parameters, databases, and other data structures may be separately stored and managed, may be incorporated into a single memory or database, may be logically and physically organized in many different ways, and may implemented in many ways, including data structures such as linked lists, hash tables, or implicit storage mechanisms. Programs may be parts (e.g., subroutines) of a single program, separate programs, distributed across several memories and processors, or implemented in many different ways, such as in a library, such as a shared library (e.g., a dynamic link library (DLL)). The DLL, for example, may store code that performs any of the system processing described above.

Various implementations have been specifically described. However, many other implementations are also possible.

What is claimed is:

1. A system for energy management of a power supply, the system comprising:
an energy storage unit; and
a control unit coupled to the energy storage unit, the control unit configured to receive a plurality of inputs and control a plurality of outputs, the control unit comprising at least one module operable to:
assign an input membership function to each of the plurality of inputs, the plurality of inputs comprising at least an available power from an energy source;
determine an output membership function for each of the plurality of outputs in response to a plurality of control states among input membership functions of the plurality of inputs; and
assign the output membership functions to each of the plurality of outputs, wherein the outputs comprise at least a rate of energy return to the energy source from the battery.

2. The system according to claim 1, wherein the plurality of inputs further comprises a stored energy level of the battery.

3. The system according to claim 2, wherein the plurality of inputs further comprises a discharge rate of stored energy of the battery to local appliances.

4. The system according to claim 3, wherein the plurality of outputs further comprises a charging rate of the battery.

5. The system according to any of claim 1, wherein each of the input membership functions corresponds to a range of input values for each of the plurality of inputs.

6. The system according to claim 5, wherein each of the plurality of outputs comprises a plurality of output membership functions, the plurality of output membership functions comprising a plurality of output levels for each of the plurality of outputs.

7. The system according to claim 6, wherein each of the plurality of outputs is converted to an analog or digital output corresponding to the output level for each of the plurality of outputs.

8. The system according to claim 1, wherein the system further comprises an inverter, the inverter operable to supply current to an alternating current power source.

9. A method for controlling power consumption in a lighting system, the method comprising:
measuring a first input comprising a brightness level of ambient light local to the lighting system;
measuring a second input comprising a level of motion local to the lighting system;
controlling an amount of light output by the lighting system in response to a plurality of predefined relationships between the brightness level and the level of motion.

10. The method according to claim 9, wherein the lighting system increases the amount light output in response to an in the level of motion.

11. The method according to claim 10, wherein the level of motion is measured based on an amount of motion in an area local to the lighting system measured over a predetermined period of time.

12. The method according to claim 11, wherein the lighting system increases the amount light output in response to a decrease in ambient light.

13. The method according to claim 12, wherein the first input and the second input are converted into a plurality of membership functions corresponding to the plurality of predefined relationships.

14. The method according to claim 13, wherein the amount of light output by the lighting system may comprises a plurality of brightness settings activated in response to the plurality of predefined relationships.

15. A device for controlling a fluid flow rate, the device comprising a flow control device being operable to adjust the fluid flow rate in response to a control signal from a controller, the controller comprising at least one module operable to:
monitor a first input, the first input corresponding to a presence detection;
monitor a second input, the second input corresponding to a motion detection; and
configure an output to the flow control device to control the fluid flow rate in response to a plurality of predefined relationships between the first input and the second input.

16. The device according to claim 15, wherein the presence detection corresponds to the proximity of an object relative to a target fluid flow location.

17. The device according to claim 16, wherein the motion detection corresponds to a rate of change of motion.

18. The device according to claim 17, wherein the fluid flow rate is increased in response to the rate of change of motion increasing.

19. The device according to claim 18, wherein the flow control device comprises a transducer.

20. The device according to any of claim 15, wherein at least the first input comprises a first input range, the first input range corresponding to a first plurality of membership functions, the second input comprises a second input range, the second input range corresponding to a second plurality of membership functions, wherein the relationship between the first plurality of membership functions and the second plurality of membership functions corresponds to the plurality of control states.
